(19) United States
(12) Patent Application Publication
(10) Pub. No.: US 2014/0318641 A1
(43) Pub. Date: Oct. 30, 2014

(54) VALVE SENSOR ARRANGEMENT FOR MOTOR VEHICLE AIR CONDITIONING SYSTEMS

(71) Applicant: HALLA VISTEON CLIMATE CONTROL CORP., Daejeon-si (KR)

(72) Inventors: Andrea Gentile, Euskirchen (DE); Frank Schmitz, Bergisch Gladbach (DE)

(21) Appl. No.: 14/361,939

(22) PCT Filed: Nov. 30, 2012
(86) PCT No.: PCT/EP2012/074148

§ 371 Date: May 30, 2014

(30) Foreign Application Priority Data
Nov. 30, 2011 (DE) 102011055892.6
Sep. 28, 2012 (DE) 102012109206.0

(51) Int. Cl. F16K 31/02

(52) U.S. Cl. CPC F16K 31/02
USPC 137/487.5; 251/129.04

(57) ABSTRACT

The invention relates to a valve sensor arrangement (1) having a valve body (12) which can be operated electrically, an electric drive (4) which is designed for that purpose, a local open-loop and closed-loop control device (5) and a communication interface (6), wherein the components (2, 4, 6) are embodied integrated into a valve housing (12), and sensors (8) can be located in sensor plug-in locations (13) and can be connected via electrical terminals (7) arranged on the valve housing (12) to the local open-loop and closed-loop control device (5) of the valve sensor arrangement (1), wherein the sensor plug-in locations (13) are integrated into the valve housing (12).

The invention relates to a valve sensor arrangement that is particularly suitable for applications in motor vehicle air conditioners.

In modern electrically or hybrid powered motor vehicles, the air conditioning systems are often equipped with a heat pump functionality, since the waste heat of the drive system and the components is no longer sufficient to heat the passenger compartment adequately. For the development of the automotive air conditioning system, it is necessary to equip some of the components used also with enhanced functionalities, particularly the valves and the expansion devices. It is characteristic of complex refrigeration systems/heat pump systems for motor vehicles that additional valves are required for implementing the necessary refrigerant circuits and bypasses needed for the new functionalities.

The valves are generally developed as electrically powered valves and the danger exists that misconnections occur on systems with more than five electrically driven valves and that the switching operations are not performed optimally, because it becomes increasingly difficult for the centralized control system to master the complexity of the entire system.

In the prior art, a high degree of complexity in terms of the number and the cable routing of the junction lines is generated, for example, by determining the switching status of the valve.

Refrigeration systems/heat pump systems furthermore require various sensors for controlling these systems, which determine the temperature and the pressure of the refrigerant at various points of the refrigeration circuit.

In systems according to the prior art, these sensors are connected with the centralized control system of the air-conditioning system by means of electrical junction lines. With electrically powered vehicles, this ultimately creates a reduced operational range due to the increased weight as a result of the necessary additional components and lines.

Another problem is that the air conditioners require a very large number of valves and sensors in the coolant piping system and that each of these components generates a certain amount of the total leakage of the system, depending upon the mechanical interfaces. The more components are provided in a system, the greater the leakage. In order to limit the overall leakage of the system, this will require components which will meet the increased requirements in terms of the leakage limits. This leads to higher costs for the individual component, so that higher costs to prevent the leakage per component are generated, due to the greater number of components.

Difficulties furthermore are that the costs of valves with sensors for a precise determination of the valve position are very high.

Solutions are known from the prior art to equip so-called smart valves with integrated control and closed-loop modules and to decentralize closed-loop control functions.

A smart valve with a force sensor for determining the force acting on the valve body is known from WO 2011/043917 A1, for example, to measure the pressure of the flowing fluid with the valve.

WO 2010/039045 A1 discloses a water management system, which contains electrically controlled valves, which can measure the pressure and the flow and are controlled by means of an open-loop and a closed-loop control device

WO 2006/105523 A2 describes a smart safety valve with valve control and integrated fault indication, which is equipped with a local microprocessor and is connected with an open-loop and a closed-loop control device.

EP 1797361 A1 discloses an electrically operated valve arrangement for use in a pressure control, wherein the pressure sensor for the detection of the pressure is developed integrally in the valve body.

The object of the invention is to provide a valve sensor arrangement which can be used for refrigeration systems/heat pump systems in motor vehicles and can be produced cost-effectively and be equipped with auxiliary functions.

This object is solved by the features of the valve sensor arrangement pursuant to claim 1. Developments are stated in the dependent claims.

The object of the invention is solved in particular by a valve sensor arrangement with a valve body that can be operated electrically and an electric drive developed for that purpose, a local open-loop and closed-loop control device as well as a communication interface, wherein the above-mentioned components are designed for integration into a common valve housing. Sensors can furthermore be placed in sensor slots and be connected to the local open-loop and closed-loop control device by means of electrical connections arranged on the valve housing. The sensor slots are integrated in the valve housing, as a result of which junction points to the fluid system and thus potential leakage possibilities are reduced.

The valve sensor arrangement is advantageously developed by arranging additional analog interfaces for external sensors on the valve housing.

It is also advantageous if additional local open-loop and closed-loop control devices are formed modular for attaching onto the valve housing to reduce junction lines and information transfer.

The communication interface is preferably developed for connection to a bus system, and the local open-loop and closed-loop control device is then connected with the central open-loop and closed-loop control device by means of a bus.

A CAN bus, a LIN bus, or a similar system can be used as bus system, for example.

A valve sensor arrangement, the valve housing of which is designed as an aluminum block, is particularly robust and particularly adapted for the service conditions for mobile applications. Alternatively, the valve housing is developed as a hybrid housing in a modular design from an aluminum block and a plastic part for the actuator.

The electrical junction lines between the sensor and the local open-loop and closed-loop control device are connected with the local open-loop and closed-loop control device via connections on the valve housing. Alternatively, the electrical function lines are designed integrated in the valve housing, so that additional lines are omitted, minimizing contact and connection problems.

The junction lines between the sensor and the local open-loop and closed-loop control device are particularly preferably designed integrated as lines that are molded into the plastic part of the valve housing.

The sensors in refrigeration systems/heat pump circuits are developed as pressure, temperature, or combined pressure/temperature sensors.

According to a development of the invention it is moreover advantageous to integrate an additional valve position sensor in the valve sensor arrangement. A rotary field sensor can be advantageously used as a valve position sensor for the position of the shaft.

Sensor slots are provided on the valve housing for the sensors, into which the sensors can be inserted by means of standardized connections, if necessary. The sensor slots can be closed by means of dummy caps, and the valve sensor arrangement is thus developed for operation also without inserted sensors. This can result in additional cost reductions, since redundant sensor slots do not have to be operated.

The concept of the invention is to provide a smart valve, which uses a local intelligence of the respective component. A further aspect of the invention consists in that the cabling of sensors and valves itself is integrated into the valves together with the sensors. In addition to the electric motor, the electrically actuated valves contain a hardware and software driver, a bus interface, and interfaces for the sensors.

It is particularly advantageous that the proposed valve sensor arrangement permits the valve to be controlled relative to its valve position without having to realize additional expense for separate position sensors. This solution in particular facilitates the positions of a valve to be controlled after the conditions of the neighboring system were analyzed.

The valve can open or close by means of open or closed-loop control, when a predetermined pressure or a predetermined temperature is reached.

A further advantage of the system consists by the integration of sensors in the valves in that less mechanical interfaces and thus potential leakage positions exist than in conventional systems. Moreover, the number of components, the junction lines between the components, and thereby also the weight, are reduced.

Furthermore, it is possible to save on highly precise but costly feedback sensors for determining the valve control positions, also called the “valve positions.” Using the proposed solution, the valve position diagnosis can be determined with sufficient reliability by a relatively simple comparison, such as determining the pressure upstream and downstream of the valve.

Due to the existing local intelligence of the valve, it can operate independently of the central control in certain situations and make positioning movements.

The valve sensor arrangement can also notify the information of the integrated sensors in the arrangement and the switching status to the central open-loop and closed-loop control device via a bus interface.

In refrigerating systems and heat pump systems of the prior art, each valve and each sensor has its own direct connection to the central open-loop and closed-loop control device.

To sum up, the invention relates to an electrical valve sensor arrangement, comprising a local open-loop and closed-loop control device, wherein hardware and software drivers as well as a communication interface are provided. The electric valve sensor arrangement furthermore comprises integrated sensors for temperature, pressure and combined temperature and pressure sensors, and the electrical and mechanical connecting means are integrated in the arrangement.

An important aspect of the invention is that the valve logic integrated in the local open-loop and closed-loop control device is capable of reading all sensor information and the valve position at desired conditions, such as at a specific pressure difference, for example. Thus, there is no longer the need to provide a costly internal feedback sensor.

The proposed valve sensor arrangement can be operated by software with different control systems. The arrangement according to the invention is a self-contained component, which however is capable to determine the ambient parameters, such as temperature and pressure, and to control the valve under specific circumstances independently and place it into the desired position without resorting to the central open-loop and closed-loop control device.

In addition, the central open-loop and closed-loop control device is continuously notified as to the temperature and the pressure prevailing in the valve sensor arrangement, by using a suitable bus system for example a LIN bus system or a CAN bus system.

Various types of actuators from the prior art are suitable as actuators for the valve sensor arrangement.

The junction lines and the mechanical interfaces of the sensors are standardized, so that it is possible to resort to a multitude of components.

Further particulars, features and advantages of the developments of the invention result from the subsequent description of embodiments with reference to the associated drawings, as follows:

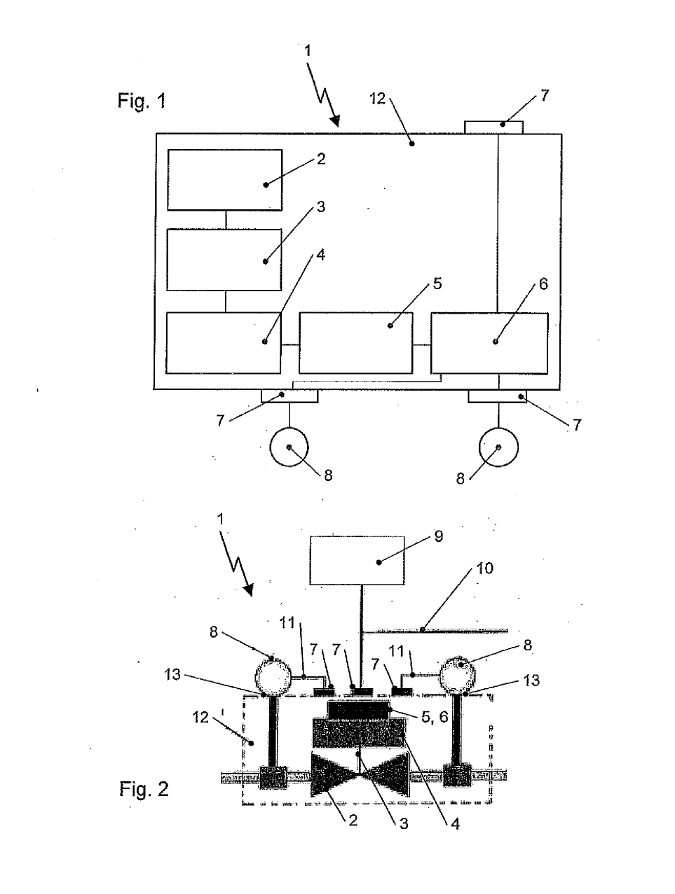

FIG. 1: shows a schematic diagram of the valve sensor arrangement with visualized information flow;

FIG. 2: shows a schematic diagram of the valve sensor arrangement with the individual components, and

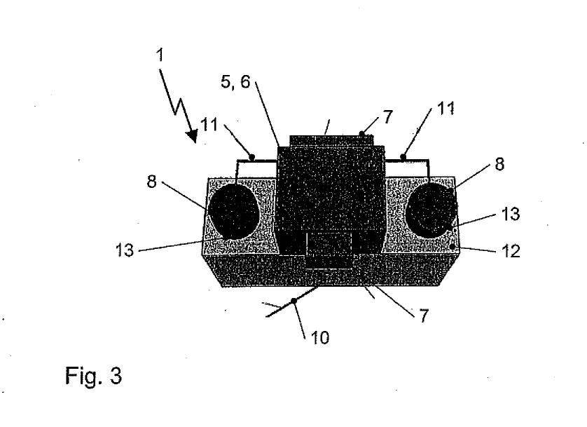

FIG. 3: shows a perspective view of a valve sensor arrangement.

FIG. 1 represents a valve sensor arrangement 1 as a schematic diagram with visualized information and active flow. The individual components of the valve sensor arrangement 1 are integrated in the valve housing 12, or are disposed therein. On the valve housing 12, connections 7 are located which are designed as electrical and mechanical connections or connectors for plug connections for the sensors 8 and for the connection to a central open-loop and closed-loop control device via a bus system.

The valve body 2 is actively connected to the valve bolt 3 and an electric drive 4. The local open-loop and closed-loop control device 5 controls the valve body 2 of the electric drive of 4 and the valve pin 3. The local open-loop and closed-loop control device is in connection with a communication interface 6, which is also integrated into the valve sensor arrangement 1. As already previously described, the communication interface 6 can be connected via a connection 7 and a bus system with a central open-loop and closed-loop control device [not shown]. The communication interface 6 is furthermore connected with the sensors 8 via various connections 7.

FIG. 2 shows a schematic diagram of the valve sensor arrangement 1 and its individual components. In this context, the valve body 2 and the fluid lines that can be shut off by means of it are indicated schematically and integrated into the valve housing 12. The valve body 2 is moved by means of the valve bolt 3, which itself is driven by the electric drive 4. The electric drive 4 is controlled by the local open-loop and closed-loop control device 5, wherein the open-loop and closed-loop control device 5 in FIG. 2 contains also the communication interface 6. Furthermore indicated are the sensors 8 that are inserted in the sensor slots 13 of the valve housing 12 and which are electrically connected by means of junction lines 11 and connections 7 with the communication interface 6 and are connected by means of same with the local open-loop and closed-loop control device 5. The sensor slots 13 are optimized to the effect so that the sensors 8 can be placed in the valve housing 12 and that only a mechanical connection exists, which has to be appropriately sealed. This is particularly important for the use of the valve sensor arrangement 1 for refrigeration systems and heat pump systems, since the leakage of these systems represents a very large problem in terms of economic and ecological perspectives, and thus requires great efforts to minimize the loss of refrigerant from mobile refrigeration system applications.

A bus system 10 can be connected to the valve sensor arrangement 1 via a connection 7, which connects same with a central open-loop and closed-loop control device 9, if necessary.

FIG. 3 is a perspective view of a valve sensor arrangement 1, which comprises an aluminum block as valve housing 12, on the top side of which two sensors slots 13 are developed, in which two sensors 8 are inserted. The junction lines 11 of the sensors 8 are respectively connected via a connection 7 with the communication interface 6 of the local open-loop and closed-loop control device 5, which is developed on the top side of the valve sensor arrangement 1. According to an alternative development, the local open-loop and closed-loop control device 5 is developed modular and can be connected with the valve sensor arrangement 1 by means of a corresponding connection on the valve housing 12. The local open-loop and closed-loop control device 5 can then be modular, depending on the application field of the valve sensor arrangement 1, same as also the sensors 8, be replaced, and can thus be flexibly adapted specifically for corresponding applications. The valve sensor arrangement 1 is connected by means of a bus system 10 with a central open-loop and closed-loop control device.

A further development can be seen in that the valve sensor arrangement is directly integrated in the electrical refrigerant compressor.

### LIST OF REFERENCE SYMBOLS

1 Valve sensor arrangement
2 Valve body
3 Valve bolt, shaft
4 Electric drive
5 Local open-loop and closed-loop control device, microprocessor
6 Communication interface
7 Connection
8 Sensor
9 Central open-loop and closed-loop control device
10 Bus
11 Junction lines
12 Valve housing
13 Sensor plug-in location

1. A valve sensor arrangement (1) having a valve body (2) which can be operated electrically, an electric drive (4) which is designed for that purpose, a local open-loop and closed-loop control device (5) and a communication interface (6), wherein the components (2, 4, 5, 6) are embodied integrated into a valve housing (12), and that sensors (8) can be placed in sensor plug-in locations (13) and can be connected via electrical connections (7) arranged on the valve housing (12) to the local open-loop and closed-loop control device (5) of the valve sensor arrangement (1), wherein the sensor plug-in locations (13) are integrated into the valve housing (12).

2. The valve sensor arrangement (1) according to claim 1, characterized in that additional analog interfaces for external sensors are arranged on the valve housing (12).

3. The valve sensor arrangement (1) according to claim 1, characterized in that additional local open-loop and closed-loop control devices are developed as a module that can be attached onto the valve housing (12).

4. The valve sensor arrangement (1) according to claim 1, characterized in that the communication interface (6) is developed for the connection onto a bus system and the local open-loop and closed-loop control device (5) are connected with the central open-loop and closed-loop control device (9) via a bus (10).

5. The valve sensor arrangement (1) according to claim 1, characterized in that the communication interface (6) is developed for the connection onto a LIN or CAN bus.

6. The valve sensor arrangement (1) according to claim 1, characterized in that the valve housing (12) is developed as an aluminum block.

7. The valve sensor arrangement (1) according to claim 1, characterized in that the valve housing (12) is developed as a modular hybrid housing from an aluminum block and a plastic part for the actuator.

8. The valve sensor arrangement (1) according to claim 1, characterized in that the junction lines (11) between sensor (8) and the local open-loop and closed-loop control device (5) are developed integrated into the valve housing (12).

9. The valve sensor arrangement (1) according to claim 8, characterized in that the junction lines (11) between sensor (8) and the local open-loop and closed-loop control device (5) are developed integrated in the plastic part of the valve housing (12) as mold-in lines.

10. The valve sensor arrangement (1) according to claim 1, characterized in that the sensors (8) are developed as pressure, temperature, or combined pressure/temperature sensors.

11. The valve sensor arrangement (1) according to claim 8, characterized in that an additional valve position sensor is integrated in the valve sensor arrangement (1) as a rotary field sensor.

12. The valve sensor arrangement (1) according to claim 1, characterized in that the sensor plug-in locations (13) can be closed by means of dummy caps and that the valve sensor arrangement (1) is developed so that it can be operated without inserted sensors (8).
